(19) United States
(12) Patent Application Publication
(10) Pub. No.: US 2004/0039873 A1
(43) Pub. Date: Feb. 26, 2004

(54) Management system for access control modes of a DRAM module socket

(76) Inventor: Hou-Yuan Lin, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/064,816

(22) Filed: Aug. 21, 2002

(51) Int. Cl. G06F 12/00

(52) U.S. Cl. 711/105

(57) ABSTRACT

A management system is provided for access control modes of a dynamic random access memory (DRAM) module socket. The management system includes a basic input/output system (BIOS), an integrated chipset, two switches, and a DRAM module socket. The two switches are respectively connected between an ECC/CKE and a DQM/CKE mode output port of the integrated chipset, and an ECC, a CKE, and a DQM mode input port of the DRAM module socket. The management system utilizes general purpose input/output (GPIO) terminals of the integrated chipset to control on/off states of the two switches so as to switch between both the ECC, the CKE, and the DQM mode input ports of the DRAM module socket. Software reconfigurations, by way of the BIOS, for DRAM access control modes are thus made possible.

### BACKGROUND OF INVENTION

1. Field of the Invention

The present invention relates to a management system, and more specifically, the present invention discloses a management system for access control modes of a DRAM module socket.

2. Description of the Prior Art

With the rapid development of computer technology, demands for both power saving and data integrity increase day by day. These demands drive motherboard research engineers to research and design a great deal of related technology, such as Error Correction Codes (ECC) and Suspend to Disk (STD) functionality.

ECC technology is most commonly performed in the memory module of a computer, and is used to correct errors that are detected in the data of the memory module during a data access process when a motherboard of the computer is provided with the appropriate ECC technology. STD technology is used to re-start computer memory with desired data, and for storing the desired data onto a hard disc just prior to the computer being switched off or entering a power saving mode. The previous state of the computer is thereby restored when the computer is woken up or powered back on. Nevertheless, the time required for restoring the operational state of the computer is close to one minute, and so STD technology requires both a lot of time and power (due to operations of the hard disk while loading the stored data into the memory). Therefore, Suspend to RAM (STR) technology was developed to replace the hard disc with a memory module (such as a DRAM module). The STR technology utilizes a self-refresh option of the memory module so as to store the desired data for re-starting the computer in the memory module itself. The resulting time for restoring operations of the computer requires only about 7 seconds, and power consumption is reduced because electricity is supplied only for the memory module. The power consumption for one memory module is less than 1 watt.

Although the aforementioned technologies work to provide error correction, power savings, and timesavings, the current technologies have some inconveniences regarding usage. For example, ECC mode functionality is supported by a north bridge chip, whereas STR mode functionality is provided by the BIOS. Motherboard support for these functions are determined by adjustments made to the motherboard hardware. For example, to support STR technology, one must switch off related jumpers on the motherboard, and then select STR support when configuring the BIOS.

Please refer FIG. 1 to FIG. 3. FIG. 1 is a block diagram of a first mode of a memory access control mode according to the prior art. FIG. 2 is a diagram a second mode of the memory access control mode according to the prior art. FIG. 3 is a diagram a third mode of the memory access control mode according to the prior art. An integrated chipset 20 comprises an ECC output port and a clock enable (CKE) output port that are designed grouped together; that is, an ECC/CKE output port for selective output. The integrated chipset 20 further comprises a data input/output mask (DQM) designed grouped with a CKE output port (i.e., a DQM/CKE port). The DQM/CKE port is used to accelerate computational speeds and to control the input/output of data, which are selectively activated with the DQM/CKE output port. The integrated chipset 20 can output any two of the ECC, the CKE, and the DQM modes; that is, the ECC (transmitting to an ECC input port of a memory module socket 30 through a data line 41) and the DQM (transmitting to a DQM input port of the memory module socket 30 through a data line 42) as shown in FIG. 1, or the CKE (transmitting to a CKE input port of the memory module socket 30 through a data line 43) and the DQM (transmitting to the DQM input port of the memory module socket 30 through the data line 42) as shown in FIG. 2, or the ECC (transmitting to the ECC input port of the memory module socket 30 through the data line 41) and the CKE (transmitting to the CKE input port of the memory module socket 30 through a data line 44) as shown in FIG. 3.

As shown in FIG. 1 to FIG. 3, two different access control modes can be selected in the memory module socket 30. The STR mode is controlled via the CKE input port so that the third configuration shown in FIG. 3 is used if the ECC mode and the STR mode are to operate simultaneously.

To enable any one of the three access control mode configurations indicated above, the motherboard must be appropriately wired to support the desired configuration. Selection of the access control mode configurations is thus not flexible, and requires physical changes to the hardware to effect a configuration change.

### SUMMARY OF INVENTION

It is therefore a primary objective of the present invention to provide a management system for access control modes of a DRAM module socket that is capable of permitting simultaneous selection of EEC, DQM, and CKE access modes according to the available hardware configuration present, and further subject to software control.

The present invention, briefly summarized, discloses a management system for access control modes of a dynamic random access memory (DRAM) module socket. The management system comprises a basic input/output system (BIOS), an integrated chipset, two switches, and a DRAM module socket. The two switches are respectively connected between an ECC/CKE and a DQM/CKE mode output port of the integrated chipset and an ECC, a CKE, and a DQM mode input port of the DRAM module socket. The management system utilizes general purpose input/output (GPIO) terminals of the integrated chipset to control the on/off state of the two switches so as to permit selection of the ECC, the CKE, and the DQM mode input ports of the DRAM module socket. Only an access control program stored in the BIOS is thus needed to perform changes to the access control configuration of the motherboard.

It is an advantage of the present invention that a user can arbitrarily choose a desired access mode combination simply by way of software selection. System configuration is thus made both easier and more flexible.

These and other objectives and advantages of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of a first mode of a memory access control mode according to the prior art.

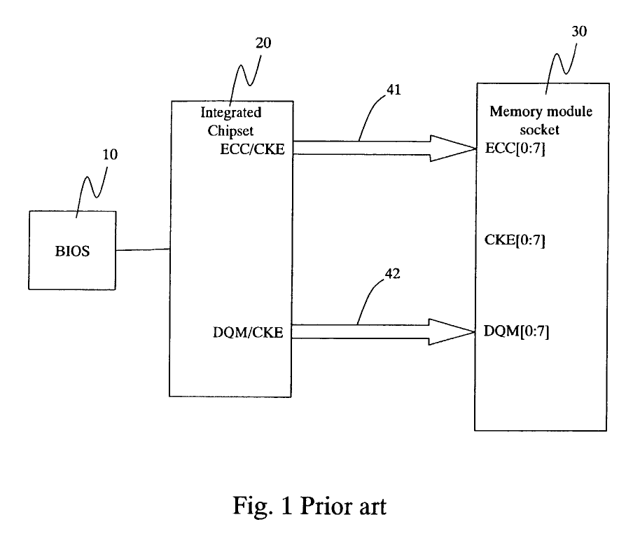

FIG. 2 is a block diagram a second mode of the memory access control mode according to the prior art.

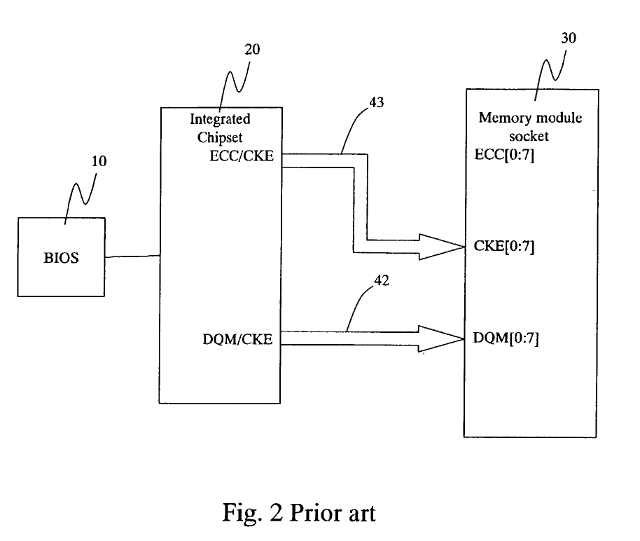

FIG. 3 is a block diagram a third mode of the memory access control mode according to the prior art.

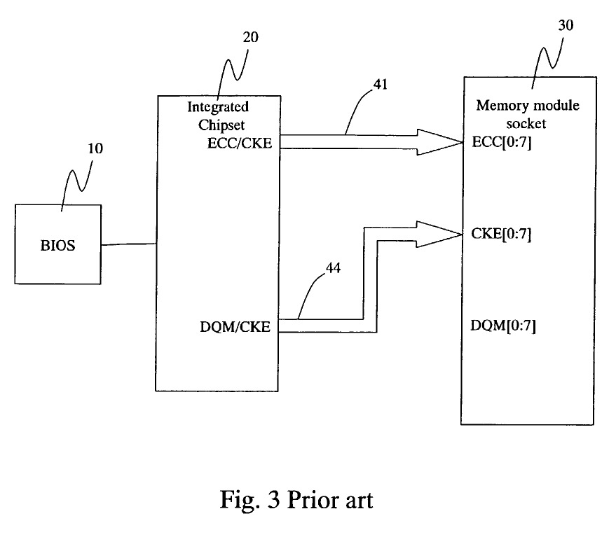

FIG. 4 is a block diagram of a first state of a management system for a DRAM module socket according to the present invention.

FIG. 5 is a block diagram of a second state of the management system for the DRAM module socket according to the present invention.

FIG. 6 is a block diagram of a third state of the management system for the DRAM module socket according to the present invention.

### DETAILED DESCRIPTION

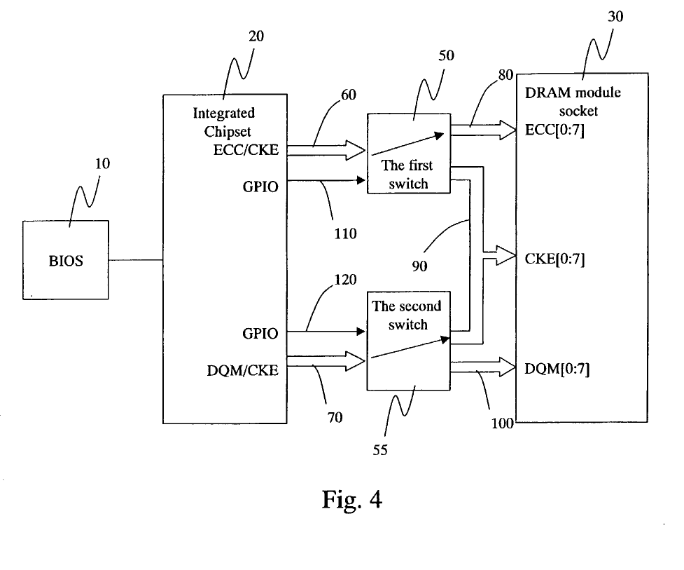

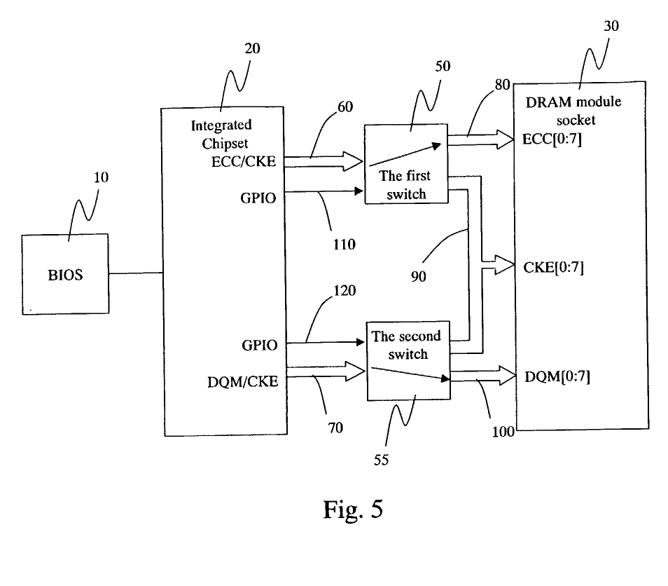

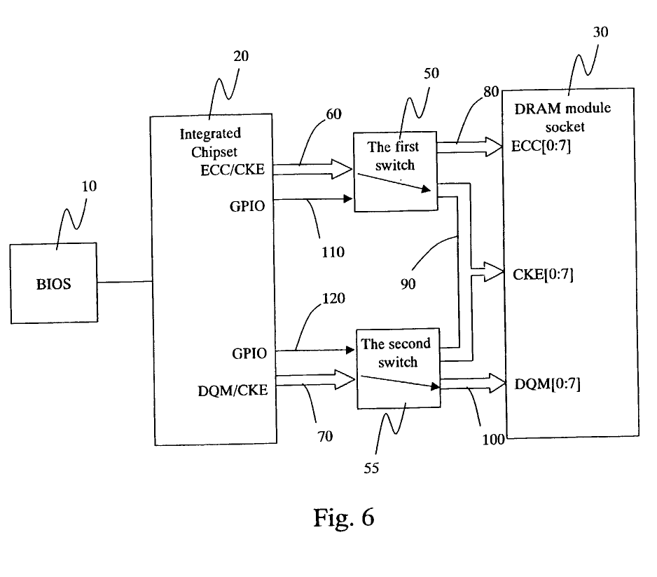

Please refer to FIG. 4, FIG. 5 and FIG. 6. FIG. 4 is a block diagram of a first state of a management system for a DRAM module socket 30 according to the present invention. FIG. 5 is a block diagram of a second state of the management system for the DRAM module socket 30 according to the present invention. FIG. 6 is a block diagram of a third state of the management system for the DRAM module socket 30 according to the present invention. The present invention provides a management system for access control modes of a dynamic random access memory (DRAM) module socket so as to perform any two of three different memory access control modes on a motherboard; that is, an error correction code (ECC) mode, a clock enable (CKE) mode, and a data input/output mask (DQM) mode. The management system comprises a basic input/output system (BIOS) 10 for storing an access control program, an integrated chipset 20, two switches 50 and 55, and a DRAM module socket 30. The chipset 20 comprises a pair of general purpose input/output (GPIO) terminals for respectively connecting to the first switch 50 and the second switch 55 through control lines 110 and 120. An ECC/CKE output port of the integrated chipset 20 is connected with the first switch 50 through a data line 60, and a DQM/CKE output port of the integrated chipset 20 is connected with the second switch 55 through a data line 70. The first switch 50 is connected to an ECC and a CKE input port of the DRAM module socket 30, respectively, through data lines 80 and 90, and the second switch 55 is connected to the CKE and a DQM input port of the DRAM module socket 30, respectively, through data lines 90 and 100.

The first switch 50 and the second switch 55 of the present invention are respectively installed on the motherboard, and the data lines 80, 90 and 100 are fixedly wired on the motherboard and connected with the aforementioned components.

FIG. 4 to FIG. 6 are three different states (three different switching modes of the switches) as provided by the present invention. The present invention management system is preferably performed in the BIOS 10 via operation of an access control program stored in the BIOS 10. The access control program transmits output control signals to the first switch 50 and the second switch 55 via the GPIO terminals on the integrated chipset 20 through control lines 110 and 120 so as to control the switching modes of the first switch 50 and the second switch 55. That is, the management system utilizes software to control the switch modes of the switches 50 and 55 to obtain three different access control mode combinations (ECC and CKE modes, ECC and DQM modes, and CKE and DQM modes). A user can thus arbitrary select different combinations of access control modes for the same motherboard.

As shown in FIG. 4, for a first configuration, the management system activates the access control program in the BIOS 10 and a first output control signal is consequently transmitted from the GPIO terminal of the integrated chipset 20 to the first switch 50 through the control line 110, which causes the first switch 50 to permit a first access control signal transmitted from the data line 60 to pass to the ECC input port of the DRAM module socket 30 by way of the data line 80 so as to enable the ECC control mode of the DRAM module socket 30. In the same manner, a second output control signal is transmitted from the other GPIO terminal of the integrated chipset 20 to the second switch 55 through the control line 120, which causes the second switch 55 to permit a second access control signal to pass from the data line 70 to the CKE input port of the DRAM module socket 30 via the data line 90 so as to enable the CKE control mode of the DRAM module socket 30. The motherboard is thus configured in an ECC/CKE setup.

As shown in FIG. 5, for a second configuration, when the management system activates the access control program in the BIOS 10, the first output control signal is transmitted from the GPIO terminal of the integrated chipset 20 to the first switch 50 through the control line 110. The first switch 50 is thereby set so that the first access control signal is transmitted from the data line 60 to the ECC input port of the DRAM module socket 30 along the data line 80, enabling the ECC control mode of the DRAM module socket 30. Similarly, the second output control signal is transmitted from the other GPIO terminal of the integrated chipset 20 to the second switch 55 through the control line 120 to cause the second switch 55 to permit the second access control signal from the data line 70 to pass to the DQM input port of the DRAM module socket 30 by way of the data line 100, thus enabling the DQM control mode of the DRAM module socket 30. This places the motherboard in an ECC/DQM configuration.

Finally, a third configuration is shown in FIG. 6. When the management system activates the access control program in the BIOS 10, the first output control signal is transmitted from the GPIO terminal of the integrated chipset 20 to the first switch 50 through the control line 110. The first switch 50 is placed into a state, according to the control line 110, that enables the first access control signal to be routed from the data line 60 to the CKE input port of the DRAM module socket 30 by way of the data line 90, thereby enabling the CKE control mode of the DRAM module socket 30. Similarly, the second output control signal is transmitted from the other GPIO terminal of the integrated chipset 20 to the second switch 55 through the control line 120. This sets the switching state of the second switch 55 such that the second access control signal is transmitted from the data line 70 to the DQM input port of the DRAM module socket 30 along the data line 100, thus enabling the DQM control mode of the DRAM module socket 30. The motherboard is consequently placed into a CKE/DQM configuration.

In contrast to the prior art, the present invention management system utilizes software to directly control a desired combination of the access control modes for a DRAM module, and thus does not require any physical reconfiguration of the hardware of a motherboard to effect such access control mode re-configurations.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A management system for a dynamic random access memory (DRAM) module socket, the management system comprising:
a basic input/output system (BIOS) for storing an access control program and outputting a control signal when the access control program is activated;
a chipset comprising a pair of general purpose input/output (GPIO) terminals and a pair of access control mode output ports, the chipset connected to the BIOS for receiving the control signal and correspondingly outputting a first control output and a second control output respectively via the GPIO terminals, and outputting a first access control signal and a second access control signal respectively via the access control mode output ports;
a dynamic random access memory (DRAM) module socket comprising three access control mode input ports; and
a pair of switches for respectively receiving the first access control signal and the second access control signal and selectively outputting the first access control signal and the second access control signal to the three access control mode input ports respectively according to the first control output and the second control output.

2. The management system of claim 1, wherein the chipset is an integrated chipset.

3. The management system of claim 1, wherein the pair of access control mode output ports are an Error Correction Code (ECC)/Clock Enable (CKE) mode output port and a Data Input Output Mask (DQM)/CKE mode output port.

4. The managing system of claim 1, wherein the DRAM module socket is a DDRDRAM socket.

5. The managing system of claim 1, wherein the DRAM module socket is a RDRAM socket.

6. The managing system of claim 1, wherein the three access control mode input ports are an ECC mode input port, a CKE mode input port and a DQM mode input port.

7. The managing system of claim 1, wherein the switches respectively receive the first control output and the second control output to selectively output the first access control signal and the second access control to two of the three access control mode input ports.
